(19) United States
(12) Patent Application Publication
(10) Pub. No.: US 2024/0353850 A1
(43) Pub. Date: Oct. 24, 2024

(54) CONTROL DEVICE AND REMOTE SUPPORT SYSTEM

(71) Applicant: TOYOTA JIDOSHA KABUSHIKI KAISHA, Toyota-shi (JP)

(72) Inventors: Kosuke AKATSUKA, Mishima-shi (JP); Yuki SUEHIRO, Susono-shi (JP); Rio SUDA, Toyota-shi (JP)

(73) Assignee: TOYOTA JIDOSHA KABUSHIKI KAISHA, Toyota-shi (JP)

(21) Appl. No.: 18/587,408

(22) Filed: Feb. 26, 2024

(30) Foreign Application Priority Data
Apr. 18, 2023 (JP) 2023-067849

(51) Int. Cl. G05D 1/224; G05D 109/10; G08C 17/02

(52) U.S. Cl. CPC G05D 1/2247; G08C 17/02; G05D 2109/10

(57) ABSTRACT

A control device is mounted on a moving body that receives a remote support based on a support signal transmitted from any one of a plurality of mobile terminals via wireless communication. The control device includes a communication device configured to perform the wireless communication with the plurality of mobile terminals, one or more processors. The one or more processors are configured, when receiving the support signal from each of the plurality of mobile terminals, to select a support terminal in accordance with priority based on a parameter of each of the plurality of mobile terminals. The support terminal is a mobile terminal that performs the remote support.

### CROSS-REFERENCES TO RELATED APPLICATION

The present disclosure claims priority under 35 U.S.C. § 119 to Japanese Patent Application No. 2023-067849, filed on Apr. 18, 2023, which is incorporated herein by reference in its entirety.

### BACKGROUND

### Technical Field

The present disclosure relates to a technique for remotely supporting a moving body by using a mobile terminal.

### Background Art

JP 2017-163253 A discloses a remote operation system. The remote operation system includes first and second remote operation devices for remote operation of a vehicle. When a signal indicating a request for switching from the first remote operation device to the second remote operation device is received from the first remote operation device, a control unit of the vehicle causes the vehicle to travel based on a control signal of the second remote operation device instead of a control signal from the first remote operation device on condition that a predetermined condition is satisfied.

### SUMMARY

In a configuration in which a remote support of a moving body is performed using a plurality of mobile terminals, support signals for the remote support may be received from the plurality of mobile terminals at the same time. When support signals are received from the plurality of mobile terminals in this way, it is desirable to be able to appropriately determine a subject that performs the remote support.

The present disclosure has been made in view of the problem described above, and an object thereof is to provide a technique that can appropriately determine a subject that performs remote support from among a plurality of mobile terminals.

A control device according to the present disclosure is mounted on a moving body that receives a remote support based on a support signal transmitted from any one of a plurality of mobile terminals via wireless communication. The control device includes a communication device configured to perform the wireless communication with the plurality of mobile terminals, one or more processors. The one or more processors are configured, when receiving the support signal from each of the plurality of mobile terminals, to select a support terminal in accordance with priority based on a parameter of each of the plurality of mobile terminals. The support terminal is a mobile terminal that performs the remote support.

A remote support system according to the present disclosure includes the moving body including the control device described above, the plurality of mobile terminals, and a sub communication terminal. The sub communication terminal is configured to display an image viewed by an operator of a specific mobile terminal being one of the plurality of mobile terminals. The specific mobile terminal includes: first communication circuitry configured to perform the wireless communication using a global communication network; and second communication circuitry configured to perform the wireless communication using a local communication network. The sub communication terminal includes communication circuitry connectable to a first local area network formed by the second communication circuitry, or a second local area network formed by a wireless router configured to wirelessly communicate with the moving body and to which the second communication circuitry belongs. The moving body includes an imaging device configured to capture an image around the moving body. When the specific mobile terminal is selected as the support terminal, the control device of the moving body transmits the image of the imaging device to the second communication circuitry or the wireless router via the communication device.

According to the present disclosure, the moving body can appropriately determine a subject that performs a remote support from among the plurality of mobile terminals.

### BRIEF DESCRIPTION OF THE DRAWINGS

FIG. 1 is a schematic diagram illustrating a configuration example of a remote support system according to an embodiment;

FIG. 2 is a schematic diagram illustrating a specific configuration example of two mobile terminals and a vehicle shown in FIG. 1;

FIG. 3 is a diagram used to describe an example of processing related to switching of a support terminal according to an embodiment;

FIG. 4 is a flowchart illustrating an example of processing related to selection of the support terminal according to an embodiment;

FIG. 5 is a schematic diagram showing a configuration example of a remote support system according to another embodiment; and

FIG. 6 is a schematic diagram showing a configuration example of a remote support system according to a still another embodiment.

### DETAILED DESCRIPTION

Embodiments of the present disclosure will be described with reference to the accompanying drawings. In the drawings, common elements are denoted by the same reference numerals, and redundant description thereof will be omitted or simplified.

### 1. Remote Support System

With regard to “remote support of a moving body”, the remote support is a concept that includes remote monitoring, remote assistance, and remote driving. Examples of the moving body include a vehicle and a robot. The vehicle may be an automated driving vehicle, or a vehicle driven by a driver. Examples of the robot include a logistics robot. As an example, in the following description, the moving body that is a target of the remote support is a vehicle. When generalizing, “vehicle” in the following description shall be deemed to be replaced with “moving body”.

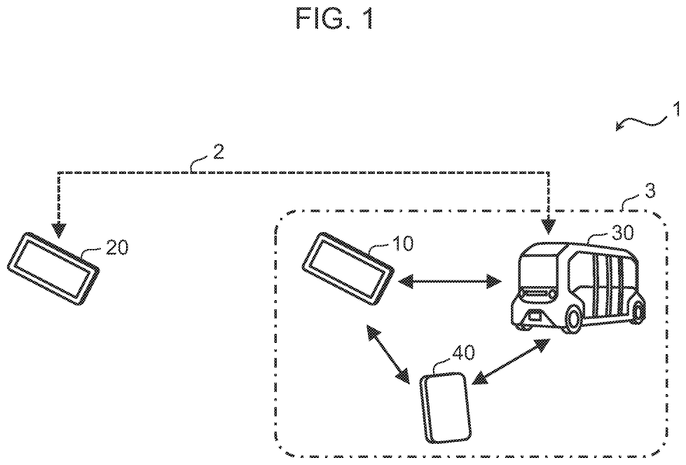

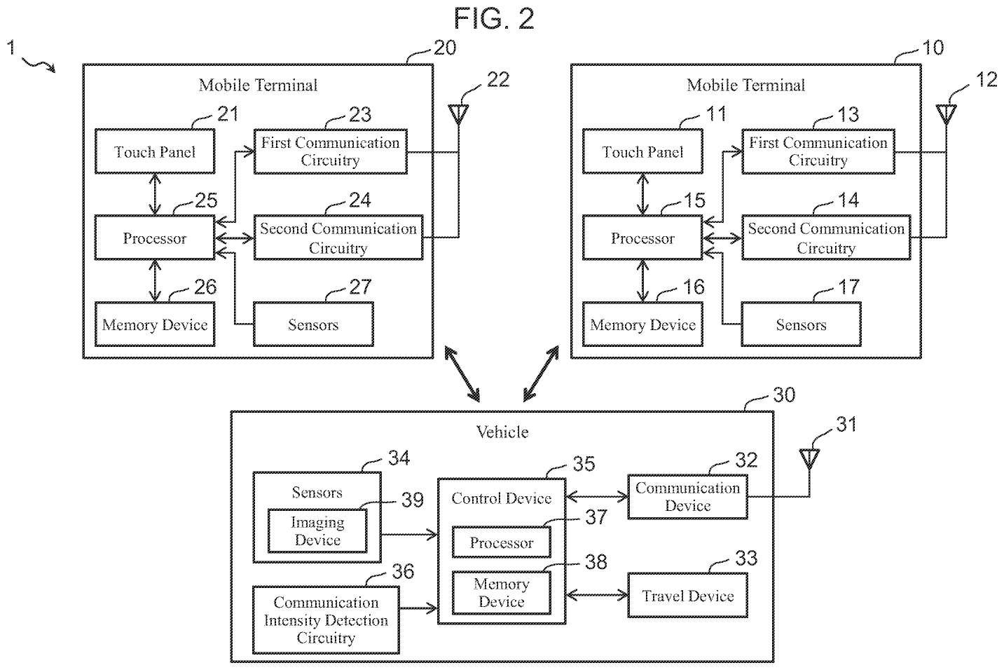

FIG. 1 is a schematic diagram illustrating a configuration example of a remote support system 1 according to an embodiment. FIG. 2 is a schematic diagram illustrating a specific configuration example of mobile terminals 10 and 20 and a vehicle 30 shown in FIG. 1. The remote support system 1 includes the two mobile terminals (or simply terminals) 10 and 20 and the vehicle 30. It should be noted that the number of “the plurality of mobile terminals” included in “the remote support system” according to the present disclosure may be three or more.

The vehicle 30 receives remote support based on a signal (support signal) transmitted from any one of the terminals 10 and 20 via wireless communication. Each of the terminals 10 and 20 is operated by an operator who performs the remote support of the vehicle 30. An example of the remote support is remote driving of the vehicle 30 using an operation of tilting the terminal 10 or 20. Each of the terminals 10 and 20 is, for example, a smartphone. However, each of the terminals 10 and 20 may be, for example, a tablet terminal (tablet personal computer) or a notebook terminal (notebook personal computer).

As illustrated in FIG. 2, the terminal 10 includes a touch panel 11, an antenna 12, first communication circuitry 13, second communication circuitry 14, a processor 15, a memory device 16, and sensors 17. The shape of the terminal 10 is not particularly limited, but the terminal 10 is formed in a rectangular plate shape as shown in FIG. 1, for example.

The touch panel 11 is formed on one plate surface of the terminal 10 and is configured to display any images. Also, the touch panel 11 includes a touch sensor. The touch sensor is configured to detect whether or not the operator is touching the touch panel 11.

The first communication circuitry 13 is configured to perform wireless communication with the vehicle 30 by a global communication network. More specifically, the first communication circuitry 13 is configured to be able to communicate with the vehicle 30 via a wireless wide area network (WWAN) 2 provided by a communication carrier. The WWAN 2 is, for example, a communication network conforming to the communication method of Long Term Evolution (LTE).

The second communication circuitry 14 is configured to communicate with the outside of the terminal 10 by a local communication network. More specifically, the second communication circuitry 14 is configured to be able to communicate with the outside of the terminal 10 via a wireless local area network (WLAN) 3. For example, the second communication circuitry 14 communicates with the vehicle 30. The WLAN 3 is, for example, a communication network conforming to a WiFi communication method.

The processor 15 is configured to execute various processes related to the remote support of the vehicle 30. The memory device 16 is configured to store various types of information necessary for the processes by the processor 15. More specifically, the processor 15 executes various processes using various programs related to the remote support. The various programs may be stored in the memory device 16 or may be recorded in a computer-readable recording medium.

The sensors 17 include, for example, a tilt angle sensor and a position sensor. The tilt angle sensor is configured to detect a tilt angle (i.e., posture) of the terminal 10. The tilt angle sensor includes, for example, a three-axis gyro sensor. The tilt angle of the terminal 10 is used for the remote driving of the vehicle 30 using an operation of tilting the terminal 10. The position sensor includes a global navigation satellite system (GNSS) receiver and detects a position and orientation of the terminal 10.

Moreover, the processor 15 has a tethering function. More specifically, the terminal 10 can communicate with an external device by WiFi, for example. Also, the terminal 10 functions as a wireless router that relays wireless communication between the WWAN 2 and an external device (WiFi tethering). This enables the external device to be connected to the WWAN 2 via the terminal 10.

As an example, the terminal 20 includes the same configuration as the terminal 10. That is, the terminal 12 includes a touch panel 21, an antenna 22, first communication circuitry 23, second communication circuitry 24, a processor 25, a memory device 26, and sensors 27. The terminal 20 (the first communication circuitry 23) communicates with the vehicle 30 via the WWAN 2.

The vehicle 30 includes an antenna 31, a communication device 32, a travel device 33, sensors 34, a control device 35, and communication intensity detection circuitry 36. The communication device 32 communicates with the outside of the vehicle 30. For example, the communication device 32 is configured to have functions equivalent to those of the first communication circuitry 13 and the second communication circuitry 14 described above, and communicates with the mobile terminals 10 and 20. The travel device 33 includes a steering device, a drive device, and a brake device. The steering device includes an electric motor configured to steer wheels of the vehicle 30. The drive device includes one or both of an electric motor and an internal combustion engine for driving the vehicle 30. The brake device includes a brake actuator for braking the vehicle 30.

The sensors 34 include a recognition sensor, a vehicle state sensor, and a position sensor. The recognition sensor recognizes a situation around the vehicle 30. Examples of the recognition sensor include an imaging device 39, a laser imaging detection and ranging (LIDAR), and a radar. The imaging device 39 is, for example, a camera. The imaging device 39 is configured to capture an image (more specifically, a moving image) around the vehicle 30 (i.e., an on-board captured image). The vehicle state sensor detects a state of the vehicle 30. The vehicle state sensor includes a speed sensor, an acceleration sensor, a yaw rate sensor, and a steering angle sensor, for example. The position sensor detects a position and orientation of the vehicle 30. For example, the position sensor includes a GNSS receiver.

The control device 35 is a computer (for example, an electronic control unit (ECU)) configured to control the vehicle 30. The control device 35 includes one or more processors 37 (hereinafter, simply referred to as a processor 37) and one or more memory devices 38 (hereinafter, simply referred to as a memory device 38). The processor 37 executes various processes related to control of the vehicle 30. The memory device 38 stores various types of information necessary for the processes by the processor 37.

The communication intensity detection circuitry 36 is configured to detect a communication intensity I of the wireless communication network (for example, WWAN 2 and WLAN 3) to which the vehicle 30 (the communication device 32) can be connected. The communication intensity I is, for example, the radio wave intensity of the wireless communication network. Alternatively, the communication intensity I may be, for example, an index value that increases when the frequency of reception of data (for example, the support signal) from the terminal 10 or 20 increases. Further, the communication intensity I may be, for example, an index value that increases when a time period during which data (for example, the support signal) transmitted from the terminal 10 or 20 is stuck is shorter.

### 2. Network Configuration

In the remote support system 1 illustrated in FIG. 1, the terminal 20 is located at a remote location from the vehicle 30. The “remote location” mentioned here is, for example, a location far away from the vehicle 30 at least to the extent that an operator who operates the terminal 20 cannot visually recognize the vehicle 30. The terminal 20 performs a remote support from the remote location by using the WWAN 2. On the other hand, the terminal 10 is located in the vicinity of the vehicle 30. The “vicinity of the vehicle 30” mentioned here refers to, for example, a location in which an operator who operates the terminal 10 can visually recognize the vehicle 30. Further, the terminal 10 may be carried by an operator riding in the vehicle 30. The terminal 20 performs a remote support in the vicinity of the vehicle 30 using the WLAN 3. According to the remote support system 1, for example, when the support signal from the terminal 20 located at the remote location is interrupted, the terminal 10 located in the vicinity of the vehicle 30 functions as a backup. As a result, the remote support can be continued.

Specific examples EX11 to EX14 of the configuration of the wireless communication network (or simply, the network) between each of the terminals 10 and 20 and the vehicle 30 will be described with reference to FIG. 1. In addition, in any of the specific examples EX11 to EX14, the terminal 20 at the remote location has a global Internet Protocol (IP) address assigned by a communication carrier, for example.

In the specific example EX11, the terminal 10 serves to assign a global IP address to the vehicle 30 (the control device 35) and to set up the WLAN 3. More specifically, for the set-up of the WLAN 3, the terminal 10 (the processor 15) assigns a local IP address to the vehicle 30. Also, the terminal 10 has a global IP address assigned by a communication carrier. Further, the terminal 10 executes a process of assigning the global IP address to the vehicle 30 (the control device 35) using the tethering function. Thus, the vehicle 30 can be connected to the WWAN 2.

The remote support system 1 may include a wireless router 40 (see FIG. 1). The wireless router 40 is mounted on the vehicle 30, for example. The wireless router 40 can wirelessly communicate with the vehicle 30 via the WWAN 2. In the specific example EX12, the wireless router 40 serves to assign a global IP address to the vehicle 30 and to set up the WLAN 3. More specifically, the wireless router 40 has a global IP address assigned by a communication carrier. For the set-up of the WLAN 3, the wireless router 40 assigns a local IP address to each of the terminal 10 and the vehicle 30. Further, when the wireless router 40 causes the vehicle 30 to be connected to the WWAN 2, the wireless router 40 executes a process of converting the local IP address of the vehicle 30 into a global IP address.

The specific example EX13 corresponds to an example in which the vehicle 30 has a global IP address assigned by a communication carrier. In the specific example EX13, the vehicle 30 assigns a local IP address to the terminal 10 for the set-up of the WLAN 3.

The specific example EX14 corresponds to a combination of the specific examples EX11 and EX12. That is, the terminal 10 may assign a global IP address to the vehicle 30 using the tethering function. Then, the wireless router 40 may execute a process of setting up the WLAN 3.

In addition, the optimal network configuration between each of the terminals 10 and 20 and the vehicle 30 may be selected from the specific examples EX11 to EX14 at any time based on communication conditions, such as the communication intensity I, communication cost, and communication quality. Moreover, in the specific examples EX12 and EX13, the terminal 10 may not necessarily include the first communication circuitry 13. Further, in each of the specific examples EX11 to EX14, the terminal 20 may not necessarily include the second communication circuitry 24.

### 3. Selection of Support Terminal

In the remote support system 1, the vehicle 30 can receive a remote support based on a support signal from any one of the plurality of terminals 10 and 20. The mobile terminal 10 or 20 that actually performs the remote support is also referred to as a “support terminal”. The support signal from the terminal 10 is transmitted via the WWAN 2, and the support signal from the terminal 20 is transmitted via the WLAN 3.

In addition, in the example of the remote driving, the support signal is a control signal of the vehicle 30 based on the operation of tilting the terminal 10 or 20. The control signal is, for example, a target value of a control variable of the motion in at least one of the longitudinal direction and the lateral direction of the vehicle 30. The target value is, for example, one or more of a target vehicle speed, a target (longitudinal) acceleration, a target steering angle, a target yaw rate, and a target lateral acceleration. Moreover, the control signal may be basic information for calculating the target value (for example, information on the tilt angle of the terminal 10 or 20 according to the operation of tilting the terminal 10 or 20).

In order to appropriately determine (select) a subject (that is, the support terminal 10 or 20) that performs a remote support in the remote support system 1 configured as described above, the control device 35 of the vehicle 30 is configured to execute the following processing. That is, when receiving support signals from both the terminals 10 and 20, the control device 35 (the processor 37) selects a support terminal 10 or 20 in accordance with “priority PR based on a parameter P” of each of the terminals 10 and 20.

The parameter P is, for example, a distance D from the vehicle 30 to each of the terminals 10 and 20. The control device 35 calculates the distance D from the current position information of the terminals 10 and 20 received from each of the terminals 10 and 20 and the current position information of the vehicle 30. The control device 35 determines the priority PR such that the one with a shorter distance D is higher among the terminals 10 and 20. Therefore, in the example illustrated in FIG. 1, the terminal 10 with the shorter distance D is selected as the support terminal. It should be noted that, when the vehicle 30 receives support signals from three or more terminals, a mobile terminal with the shortest distance D among the three or more terminals is selected as the support terminal.

Alternatively, the parameter P may be, for example, the communication intensity (e.g., the radio wave intensity) I between the vehicle 30 and each of the terminals 10 and 20. The control device 35 may determine the priority PR such that the one with a higher communication intensity I is higher among the terminals 10 and 20. As a result, the terminal 10 or 20 with a higher communication intensity I is selected as the support terminal. It should be noted that, when the vehicle 30 receives support signals from three or more terminals, a mobile terminal with the highest communication intensity I among the three or more terminals is selected as the support terminal.

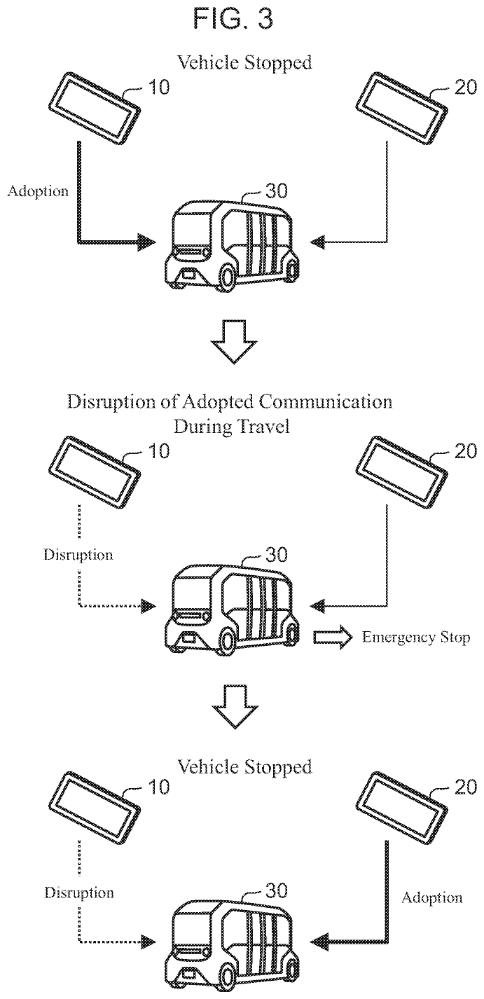

FIG. 3 is a diagram used to describe an example of processing related to switching of the support terminal according to the embodiment.

The priority PR may vary during the execution of the remote support. For example, in an example in which the distance D is used as the parameter P, when the vehicle 30 receives a support signal from the terminal 10 near the vehicle 30 during the remote support based on the support signal from the terminal 20 located at the remote location, the priority PR changes. That is, the terminal 10 having a relatively high priority PR is newly added as a candidate for performing the remote support. Therefore, an issue is how to switch the support terminal from the terminal 20 to the terminal 10.

In an example illustrated in the upper part of FIG. 3, when the priority PR changes while the vehicle 30 is traveling, the control device 35 does not change the support terminal until the traveling of the vehicle 30 stops. That is, the control device 35 switches the support terminal from the terminal 20 to the terminal 10 on condition that the vehicle 30 is stopped. In other words, the terminal 10 is adopted as the support terminal. As just described, by limiting the switching timing to when the vehicle 30 is stopped, it is possible to avoid a sudden change in the control signal for the remote support during the travel. In addition, in the example of the remote driving, it is possible to reduce a sudden change in the behavior of the vehicle 30 due to a sudden change (discontinuity) in the control signal during the travel.

Moreover, when the communication intensity I is used as the parameter P, the priority PR changes due to, for example, the occurrence of a decrease in the communication intensity I (for example, communication disruption) between the vehicle 30 and the terminal 10 or 20. The middle part of FIG. 3 illustrates a scene in which communication (radio wave) between the support terminal 10 and the vehicle 30 is disrupted during the travel. In this example, the communication intensity I between the terminal 10 and the vehicle 30 decreases due to the occurrence of the communication disruption, and the priority PR of the terminal 20 becomes higher than the terminal 10. When the communication with the terminal 10 being adopted is disrupted during the travel as described above, the control device 35 on the vehicle 30 side executes a process of causing the vehicle 30 to perform an emergency stop.

Furthermore, as illustrated in the lower part of FIG. 3, after the vehicle 30 is stopped by the emergency stop process, the control device 35 switches the support terminal from the terminal 10 to the terminal 20. In other words, the terminal 20 is adopted as the support terminal. Even with this example, it is possible to avoid a sudden change in the control signal for the remote support during the travel.

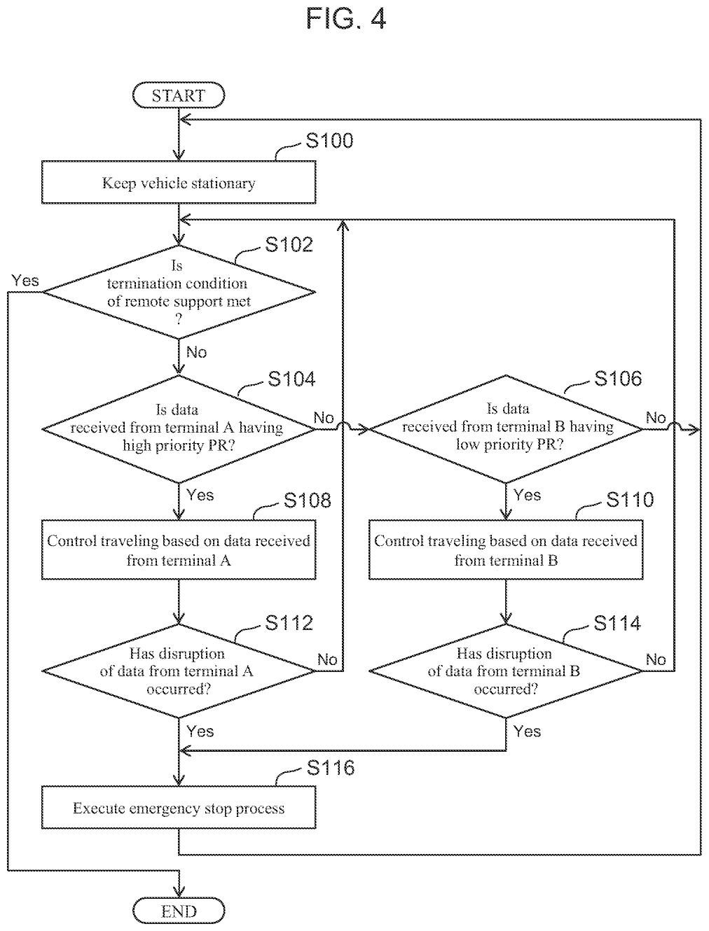

FIG. 4 is a flowchart illustrating an example of processing related to selection of the support terminal according to the embodiment. The processing of this flowchart is started, for example, when the control device 35 receives a remote support execution request from the terminal 10 or the terminal 20. In FIG. 4, the remote driving is described as an example of the remote support. In addition, the control device 35 identifies the terminal 10 and the terminal 20 by using, for example, a reception IP address from the terminal 10 or 20, a reception port of data, the length of received data, or an identification ID in the received data.

In the processing shown in FIG. 4, first, in step S100, the control device 35 (the processor 37) keeps the vehicle 30 stationary.

Next, in step S102, the control device 35 determines whether or not a designated termination condition of the remote support is met. The termination condition is met, for example, when there is no longer a remote support execution request from either of the terminal 10 and the terminal 20, or when the remote support is terminated in response to a request of the vehicle 30. When the termination condition is met, the processing illustrated in FIG. 4 is terminated.

On the other hand, when the termination condition of step S102 is not satisfied (that is, when the remote support is continued), the processing proceeds to step S104. In step S104, the control device 35 determines whether or not the data (i.e., the support signal) is received from a terminal having a relatively high priority PR, which is also referred to as a “mobile terminal A” for the sake of simplicity. Where the distance D is used as the parameter P, in the example illustrated in FIG. 1, the terminal 10 corresponds to the terminal A. In addition, in the processing illustrated in FIG. 4, the communication intensity I may be used as the parameter P.

When the data is not received from the terminal A (step S104; No), the processing proceeds to step S106. In step S106, the control device 35 determines whether or not the data (i.e., the support signal) is received from a terminal having a relatively low priority PR, which is also referred to as a “mobile terminal B” for the sake of simplicity. As a result, when the data is not received from any one of the terminals A and B (step S106; No), the processing returns to step S100.

When the data is received from the terminal A (step S104; Yes), the processing proceeds to step S108. In step S108, the control device 35 controls the traveling (i.e., the motion) of the vehicle 30 based on the data received from the terminal A. That is, the terminal A is selected as the support terminal. In addition, when the data is received from the terminal A in this way, even if the data is also received from the terminal B, the control device 35 rejects the data from the terminal B.

On the other hand, when the data is not received from the terminal A and the data is received from the terminal B (step S106; Yes), the processing proceeds to step S110. In step S110, the control device 35 controls the traveling (i.e., the motion) of the vehicle 30. That is, the terminal B is selected as the support terminal.

In step S112 following step S108, the control device 35 determines whether or not disruption of the data (i.e., communication disruption) from the terminal A has occurred. As a result, when it is determined that the communication disruption has not occurred, the processing returns to step S102. Similarly, in step S114 following step S110, the control device 35 determines whether or not disruption of the data (i.e., communication disruption) from the terminal B has occurred. As a result, when it is determined that the communication disruption has not occurred, the processing returns to step S102.

On the other hand, when it is determined in step S112 or S114 that the communication disruption has occurred, the processing proceeds to step S116. In step S116, the control device 35 executes a process of causing the vehicle 30 to perform an emergency stop. Thereafter, the processing in step S100 and the subsequent steps is repeated.

As described above, according to the present embodiment, when the support signals are received from both the terminals 10 and 20, the control device 35 selects the support terminal 10 or 20 in accordance with the priority PR based on the parameters P of the terminals 10 and 20. Thus, the subject that performs the remote support can be appropriately determined from the plurality of terminals 10 and 20.

Next, other execution examples A and B related to the “selection of the support terminal” will be described.

In the execution example A, when the support signals are received from a plurality of mobile terminals, the operation for the emergency stop of the vehicle 30 is always enabled even by a terminal that is not adopted (selected) as the support terminal. An operation from a terminal for instructing at least one of deceleration and stop of the vehicle 30 corresponds to the operation for the emergency stop. Thus, for example, an operator who carries the terminal 10 near the vehicle 30 during the remote driving can promptly stop the traveling of the vehicle 30 as necessary to ensure safety. Alternatively, for example, when another operator monitors, at a remote location, the operation of the operator who is performing the remote driving near the vehicle 30 using the terminal 10, the another operator (i.e., a remote monitor) can operate the terminal 20 to quickly stop the traveling of the vehicle 30 as necessary to ensure safety.

In addition, when the support signals are received from a plurality of mobile terminals, permission of the switching of the support terminal may not be necessarily limited to execution while the vehicle 30 is stopped as in the example described. That is, in the execution example B, the switching is always permitted. Thus, when an operator who carries the terminal 10 is in the vehicle 30, the operator can always override the remote driving of the vehicle 30. Further, when the communication of one terminal 10 or 20 is disrupted, the remote driving can be promptly continued by the other terminal 20 or 10.

### 4. Display of On-Board Captured Image on Sub Communication Terminal

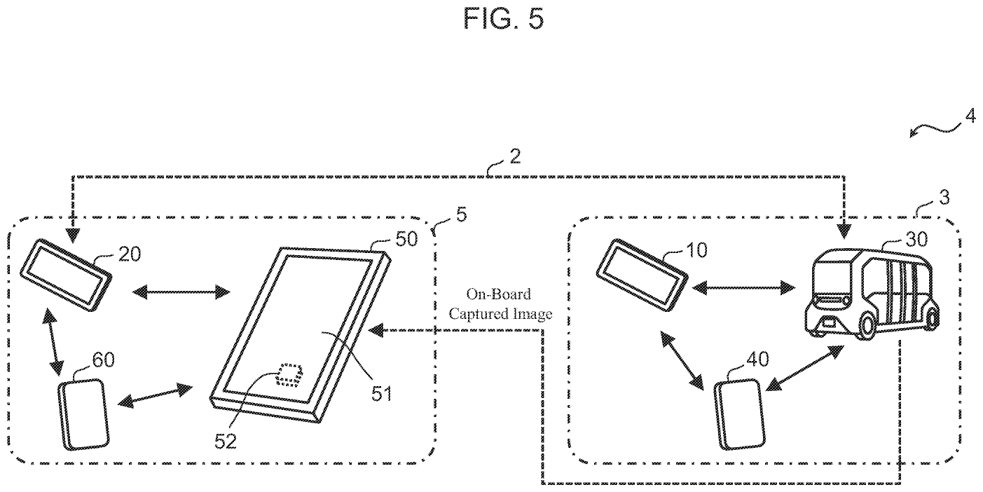

FIG. 5 is a schematic diagram showing a configuration example of a remote support system 4 according to another embodiment. The remote support system 4 is configured to be able to provide a fulfilling on-board captured image (i.e., moving image captured by the imaging device 39) to an operator who performs a remote support of the vehicle 30 using the terminal 20 from a remote location.

Specifically, the remote support system 4 is different from the remote support system 1 in that the remote support system 4 additionally includes a sub communication terminal 50. The sub communication terminal (or simply, sub terminal) 50 includes a display unit 51 that displays an image (more specifically, a moving image) viewed by the operator who operates the terminal 20. For example, the sub terminal 50 is a mobile terminal, such as a tablet terminal. However, the sub terminal 50 may not necessarily be a mobile terminal, and may be a fixed terminal.

Additionally, as an example, the terminal 20 is a smartphone, and the sub terminal 50 is a tablet terminal. When the operator operates the terminal 20 to perform the remote driving, the sub terminal 50 is used in a remote cockpit together with the terminal 20, for example. In addition, in an example illustrated in FIG. 5, the terminal 20 corresponds to a “specific mobile terminal” according to the present disclosure.

The sub terminal 50 includes communication circuitry 52 for acquiring an on-board captured image from the vehicle 30 by wireless communication, together with a processor and a memory device. In order to display the on-board captured image on the sub terminal 50, it is conceivable to assign a global IP address to the sub terminal 50 and transmits the on-board captured image from the vehicle 30 via the WWAN 2. For example, the network configuration for assigning the global IP address to the sub terminals 50 is formed as in the following specific examples EX21 and EX22.

In the specific example EX21, the terminal 20 serves to assign a global IP address to the sub terminal 50 and to set up a WLAN 5. That is, the terminal 20 assigns a local IP address to the sub terminal 50 for the set-up of the WLAN 5. Further, the terminal 20 executes a process of assigning a global IP address to the sub terminal 50 by using a tethering function.

In the specific example EX21, when the terminal 20 is selected as the support terminal, the control device 35 of the vehicle 30 transmits an on-board captured image to the second communication circuitry 24 of the terminal 20 via the communication device 32. Thus, the on-board captured image from the vehicle 30 can be provided to the sub terminal 50 via the terminal 20 by using the WWAN 2. In addition, the WLAN 5 in the specific example EX21 corresponds to an example of the “first local area network” according to the present disclosure.

Next, the specific example EX22 corresponds to an example in which the remote support system 4 includes a wireless router 60. The wireless router 60 is arranged in the remote cockpit together with the terminal 20 and the sub terminal 50, for example. The wireless router 60 can wirelessly communicate with the vehicle 30 via the WWAN 2. In the specific example EX22, the wireless router 60 serves to assign a global IP address to the sub terminal 50 and to set up the WLAN 5. That is, the wireless router 60 assigns a local IP address to each of the terminal 20 and the sub terminal 50 for the set-up of the WLAN 5. Further, when the sub terminal 50 is connected to the WWAN 2, the wireless router 60 executes a process of converting the local IP address of the sub terminal 50 into a global IP address.

In the specific example EX22, when the terminal 20 is selected as the support terminal, the control device 35 transmits an on-board captured image to the wireless router 60 via the communication device 32. Thus, the on-board captured image from the vehicle 30 can be provided to the sub terminal 50 via the wireless router 60 by using the WWAN 2. In addition, the WLAN 5 in the specific example EX22 corresponds to an example of the “second local area network” according to the present disclosure.

Additionally, in the specific example EX22, the wireless router 60 may also assign a global IP address to the terminal 20. Then, the terminal 20 (the processor 25) may select either global communication using the first communication circuitry 23 or global communication using the second communication circuitry 24 and the wireless router 60, based on the communication state of each of the first communication circuitry 23 and the second communication circuitry 24. The communication state may be determined based on a designated condition regarding, for example, the radio wave intensity.

According to the remote support system 4 described above, the environment of the remote support using the terminal 20 at a remote location can be appropriately enriched by displaying the on-board captured image on the sub terminal 50.

### 5. Extended Display of On-Board Captured Image

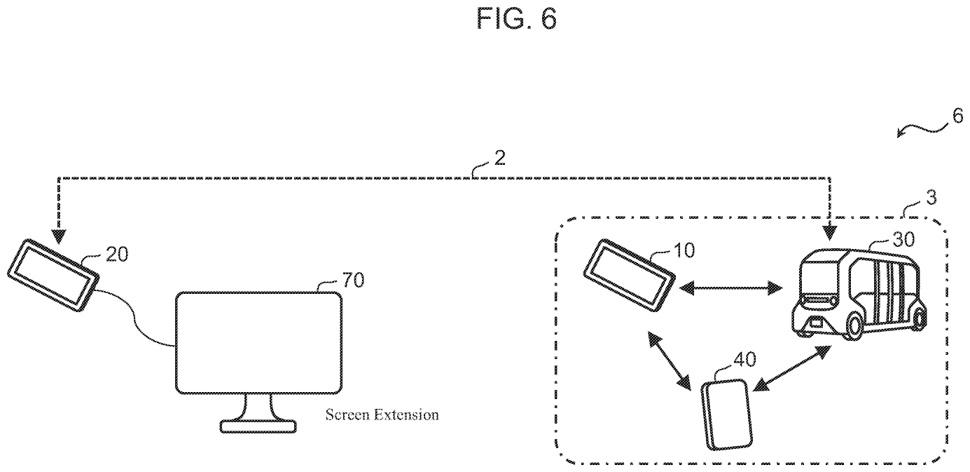

FIG. 6 is a schematic diagram showing a configuration example of a remote support system 6 according to a still another embodiment. The remote support system 6 is different from the remote support system 1 in that the remote support system 6 additionally includes a monitor 70. The monitor 70 is connected to the terminal 20 by wire. With this kind of configuration, the on-board captured image received by the terminal 20 may be displayed in an extended manner on the monitor 70. In addition, another display device, such as virtual reality (VR) goggles may be used for the extended display of the on-board captured image.

What is claimed is:

1. A control device mounted on a moving body that receives a remote support based on a support signal transmitted from any one of a plurality of mobile terminals via wireless communication, comprising:
a communication device configured to perform the wireless communication with the plurality of mobile terminals; and
one or more processors configured, when receiving the support signal from each of the plurality of mobile terminals, to select a support terminal in accordance with priority based on a parameter of each of the plurality of mobile terminals, wherein the support terminal is a mobile terminal that performs the remote support.

2. The control device according to claim 1, wherein
the parameter is distance from the moving body to each of the plurality of mobile terminals, and
the one or more processors select, as the support terminal, a mobile terminal with a shortest distance among the plurality of mobile terminals.

3. The control device according to claim 1, wherein
the parameter is communication intensity between the moving body and each of the plurality of mobile terminals, and
the one or more processors select, as the support terminal, a mobile terminal with a highest communication intensity among the plurality of mobile terminals.

4. The control device according to claim 1, wherein
when the priority changes during travel of the moving body, the one or more processors do not change the support terminal until the moving body stops traveling.

5. A remote support system, comprising:
the moving body including the control device according to claim 1;
the plurality of mobile terminals; and
a sub communication terminal configured to display an image viewed by an operator of a specific mobile terminal being one of the plurality of mobile terminals, wherein
the specific mobile terminal includes:
first communication circuitry configured to perform the wireless communication using a global communication network; and
second communication circuitry configured to perform the wireless communication using a local communication network,
the sub communication terminal includes communication circuitry connectable to a first local area network formed by the second communication circuitry, or a second local area network formed by a wireless router configured to wirelessly communicate with the moving body and to which the second communication circuitry belongs,
the moving body includes an imaging device configured to capture an image around the moving body, and
when the specific mobile terminal is selected as the support terminal, the control device of the moving body transmits the image of the imaging device to the second communication circuitry or the wireless router via the communication device.
